(19) United States
(12) Patent Application Publication
(10) Pub. No.: US 2025/0326627 A1
(43) Pub. Date: Oct. 23, 2025

(54) BEVERAGE DISPENSING NOZZLE

(71) Applicant: WILD GOOSE CANNING TECHNOLOGIES, LLC, Louisville, CO (US)

(72) Inventors: Carlo PETERMANN, Buffalo, NY (US); Daniel MOODY, Louisville, CO (US); Daniel WELCH, Louisville, CO (US); Adam MCKIM, Louisville, CO (US); Daniel NORRIS, Louisville, CO (US); Corey PEMBERTON, Louisville, CO (US)

(73) Assignee: WILD GOOSE CANNING TECHNOLOGIES, LLC, Lousiville, CO (US)

(21) Appl. No.: 19/182,837

(22) Filed: Apr. 18, 2025

Related U.S. Application Data
(60) Provisional application No. 63/636,515, filed on Apr. 19, 2024.
(60) Provisional application No. 63/636,656, filed on Apr. 19, 2024.
(60) Provisional application No. 63/648,825, filed on May 17, 2024.

(51) Int. Cl. B67D 1/14; B67D 1/07; B67D 1/08

(52) U.S. Cl. CPC B67D 1/1422; B67D 1/07; B67D 1/0857; B67D 1/0888; B67D 2001/075

(57) ABSTRACT

Beverage dispensing nozzles and methods are described, including structures and mechanisms for selectively purging desaturated gas from the nozzle before dispensing, for ensuring beverage in the nozzle is maintained and dispensed at an optimal desired temperature, for disinfecting beverage-contacting surfaces, and for electronically activating a pour, among other things.

### CROSS-REFERENCE TO RELATED APPLICATIONS

This application claims priority to U.S. Provisional Application No. 63/636,515, filed Apr. 19, 2024, U.S. Provisional Application No. 63/636,656, filed Apr. 19, 2024, and U.S. Provisional Application No. 63/648,825, filed May 17, 2024, each of which is hereby incorporated by reference in its entirety.

### TECHNICAL FIELD

The subject matter of this application relates to beverage dispensing nozzles and methods for reducing the amount of foam created when dispensing a saturated (e.g., carbonated) beverage into a container. Specific examples include filling nozzles utilized to dispense carbonated beverages into containers such as cups, pitchers, cans, bottles, or the like; gas purge and cooling recirculation for reducing the amount of foam generated during dispensing, particularly following longer than average time intervals (e.g., casual drink); irradiating systems for addressing perceived nozzle sanitation questions; and/or electronic pour activation.

### BACKGROUND

Carbonated beverages, such as draft or draught beer, are commonly stored in relatively large-volume containers before being dispensed for personal consumption to smaller-volume containers, such as glasses, cups, pitchers, cans, bottles, and the like. Beer, for example, may be stored under pressure in large volume metal kegs of various sizes (e.g., 50 L, ½ barrel (15.5 gall), ¼ barrel (7.75 gal), and ⅙ barrel (5.2 gal)). To dispense the beer from a keg, a coupler may be applied to the keg to permit external gas such as carbon dioxide or nitrogen to be introduced into the keg, and to permit pressurized beer to be withdrawn from the keg and conveyed to a dispensing tap. Conventional commercial beer systems dispense at a flow rate between approximately 2.5 to 3.8 L/min (1 gal/min), and in some high-speed cases as high as 6 to 8 L/min (over 2 gal/min), depending on the consumer market and the type of beer. Industrial beer systems dispense at a flow rate of approximately 6-8 L/min.

One of the issues with dispensing beer and other such gas saturated beverages is the creation of unwanted foam during the dispensing process. This foam is created by release of solubilized gas from the liquid beverage, referred to as “desaturation.” Foaming generates waste of the beverage. For example, it is estimated that as much as approximately 25% of beer is wasted when dispensed from a keg using conventional systems and methods. Various conventional systems have been proposed for increasing keg yield by reducing waste, but each may suffer from one or more limitations. Examples of conventional systems and limitations are described in the background section of U.S. Pat. No. 10,662,053. U.S. Pat. No. 10,662,053 goes on to describe alternative fluid dispensing systems and methods for reducing foaming. These systems and methods may be used in combination with the units, systems, and methods described herein. U.S. Pat. No. 10,662,053 is incorporated by reference in its entirety.

U.S. Pat. No. 10,662,053 describes dispense nozzles used to fill beverage containers from the bottom of the container up. So-called “bottom fill” nozzles have advantages over other types of nozzles. For example, bottom fill nozzles dispense beverage at or near the bottom surfaces of the fill container, which minimizes or prevents unwanted agitation (e.g., splashing) of the beverage at the beginning and throughout the pour that could lead to undesirable foaming. There is a saying in the dispense world that “foam creates foam.” With a bottom fill, the initial foam generated quickly rises to the top of the liquid and away from the fill point. In contrast, with standard dispense systems the pour is always from the top directly onto the beverage and any foam already present. This always creates additional foam, and is a particularly challenging issue for example in bars with inexperienced (or rushed) bartenders.

One of the challenges with prior art nozzles, including bottom fill nozzles, is that beverage may be contained within the nozzle between pours. This beverage tends to warm over time between pours, leading to desaturation and even spoiling. When beer desaturates in the nozzle, carbon dioxide gas is released from the solution and forms a gas pocket in the nozzle. When the nozzle is subsequently activated for a new pour, this gas pocket acts as a propellant, propelling the liquid from the nozzle in an initial surge, resulting in splashing and undesirable foaming, and ultimately a ruined (and wasted) pour.

Another aspect of bottom fill technology is related to the fact that an outer exposed portion of the nozzle is intended to contact the beverage during the fill. Although bottom fill technology is widely used in beer packaging applications, for example, there is a misperception that this technology may be unhygienic in some circumstances.

There is an unmet need in the field for units, systems, and methods for reducing the amount of foam created when dispensing carbonated and similar beverages into containers, and for addressing perceived sanitary concerns regarding bottom fill technology. Examples below satisfy these unmet needs in various ways.

The subject matter described and illustrated U.S. Provisional Application No. 63/636,656 (incorporated by reference) is suitable for combination and use with the invention(s) described in this application and such combinations are contemplated by the inventors as within the scope of their invention.

### BRIEF DESCRIPTION OF THE DRAWINGS

FIG. 1 is a cross-section illustrating aspects of a beverage dispensing nozzle as described herein.

FIG. 2 is a top cross-sectional view of the beverage dispensing nozzle illustrated in FIG. 1.

FIG. 3 is a schematic illustrating various components of an example of a beverage dispensing system.

FIG. 4 is a front view illustrating aspects of a beverage dispensing nozzle as described herein.

FIGS. 5A, 5B, and 5C are schematics illustrating aspects of a beverage dispensing nozzle with electronic pour activation as described herein.

FIG. 6 is a schematic illustrating aspects of a beverage dispensing nozzle with electronic pour activation as described herein.

FIG. 7 is a schematic illustrating aspects of a beverage dispensing nozzle with electronic pour activation as described herein.

FIG. 8 is a schematic illustrating aspects of a beverage dispensing nozzle with electronic pour activation as described herein.

### DETAILED DESCRIPTION

For the purpose of promoting an understanding of the principles of the inventions, reference will now be made to various examples illustrated and described in the drawings and throughout this application, including in the specification and claims as well as in the subject matter incorporated by reference. These examples are intended to be non-exhaustive, and no limitation of the scope of the inventions described and claimed herein is intended. Additional examples within the scope of these inventions are contemplated and would be apparent to a person of ordinary skill in the art, including alterations and modifications to specific examples described herein, and further applications of the principles of the inventions. For example, while the examples below refer to beer, the scope of the inventions is not so limited and includes other suitable beverages.

Unless otherwise indicated, all numbers used herein to express quantities, dimensions, degrees, and the like, should be understood as being modified in all instances by the term “about,” and that term would be understood to encompass standard mechanical tolerances and variations as known in the art. Unless otherwise indicated, each numerical value in this disclosure is intended to encompass both the recited value and functionally equivalent values/ranges surrounding that value.

The use of the singular includes the plural unless specifically stated otherwise and the use of the terms “and” and “or” means “and/or” unless otherwise indicated. The use of the terms “comprising,” “including,” “having,” “regarding,” and the like are non-exclusive and non-limiting.

The term “keg” is used broadly to refer to a pressurized vessel used to store and dispense a beverage in bulk, without limitation as to size, dimension, composition, material, or stored and dispensed beverage. Kegs may be made of any material suitable for the particular intended use, including for example stainless steel, aluminum, glass, plastic, and wood. Examples of beverages include, but are not limited to, beer, wine, cider, soft drinks, coffee, tea, kombucha, and the like.

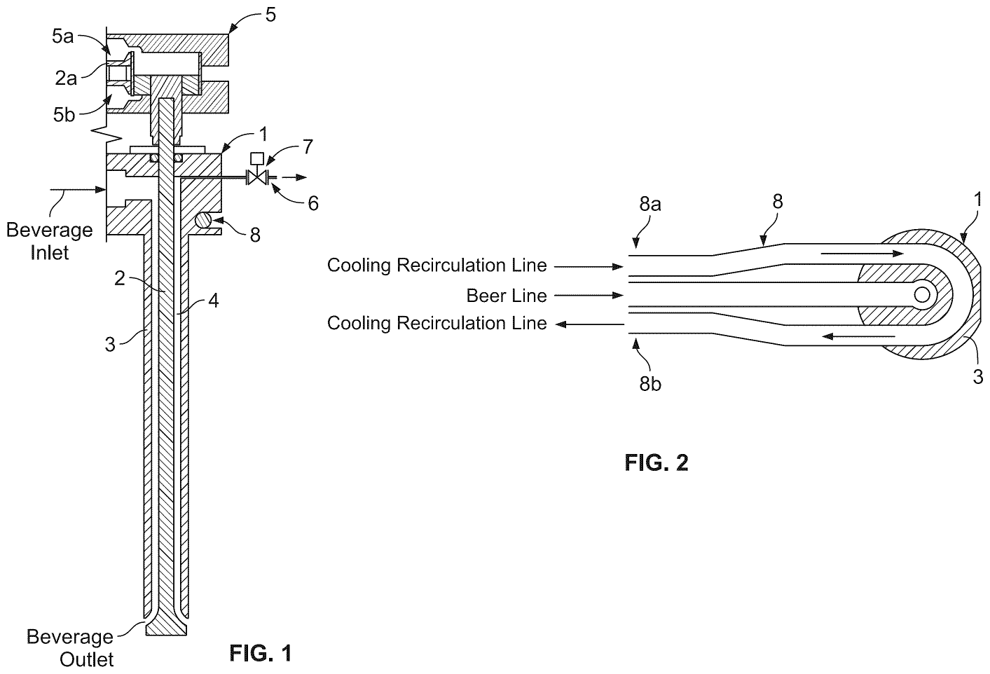

FIG. 1 illustrates aspects of a beverage dispensing system including a beverage dispensing nozzle 1. The nozzle 1 comprises an elongate actuator rod portion 2 slidingly disposed within a bore of an elongate body portion 3. The actuator rod portion 2 and body portion 3 cooperate to form a beverage flow path 4 comprising a beverage inlet in fluid communication with a beverage outlet. The actuator rod portion 3 is operable to slide with respect to the elongate body portion 3 to reversibly open and close the nozzle 1. The beverage inlet is adapted to fluidly couple to a beverage line (not shown) comprising a beverage.

FIG. 1 illustrates nozzle 1 in an open configuration. In this configuration, the distal end of the actuator rod portion 2 (the end closest to the nozzle beverage outlet) is spaced apart from the distal end of the body portion 3, creating an opening at the nozzle beverage outlet to permit beverage to flow into, through, and out of the nozzle 1. The closed configuration (not illustrated) may be obtained by sliding the actuator rod portion 2 proximally (in the direction away from the nozzle beverage outlet) relative to the body portion 3 (or vice versa). This may be accomplished, for example, by holding the body portion 3 stationary and moving the actuator rod portion 2 proximally (in the direction away from the nozzle beverage outlet), or by holding the actuator rod portion 2 stationary and moving the body portion 3 distally (in the direction of the nozzle beverage outlet). In some examples, this may be accomplished by moving the actuator rod portion 2 and body portion 3 at the same time.

Sliding the actuator rod portion 2 within the body portion 3 from the open configuration as described above results in a sealing between the distal end of the actuator rod portion 2 (the end closest to the nozzle beverage outlet) and the distal end of the body portion 3. In some examples, this sealing may be effected by an interference fit between the actuator rod portion 2 and the body portion 3. As shown in FIG. 1, for example, the distal ends of the actuator rod portion 2 and body portion 3 are shaped so that they may contact and close the beverage outlet as they move towards the closed configuration. In some examples, sealing may be effected using valves, gaskets, or the like operable to close the flow path 4 and prevent liquid from flowing out of the nozzle 1. In the closed configuration, the actuator rod portion 3 and body portion 3 cooperate to contain a volume of beverage within the nozzle 1. The sealing at the distal end of the nozzle 1 prevents beverage from flowing into, through, or out of the nozzle 1.

As shown in FIG. 1, a double acting pneumatic cylinder 5 may be provided to reversibly open and close the nozzle 1. The pneumatic cylinder 5 may comprise first and second pneumatic inlets 5a, 5b selectively operable via a pneumatic valve and gas source (not shown) to move actuator guide 2a back and forth within the cylinder 5. Starting from the open configuration illustrated in FIG. 1, pneumatic activation of inlet 5b via the valve and gas source will cause actuator guide 2a (and the entire actuator rod portion 2) to move proximally within cylinder 5 (away from the nozzle beverage outlet) relative to the body portion 3. This moves the nozzle 1 from open to closed. Conversely, from the closed configuration pneumatic activation of inlet 5a will cause actuator guide 2a (and the entire actuator rod portion 2) to move distally within the cylinder 5 (towards the nozzle beverage outlet) relative to the body portion 3. This moves the nozzle 1 from closed to open.

Nozzle 1 may be used for bottom-filling applications. In use, nozzle 1 may be placed in a container and beverage dispensed with the beverage outlet at or near the bottom surface of the container. This has the advantage of minimizing or preventing unwanted splashing at the beginning and throughout a pour that could lead to undesirable foaming.

As explained above, one of the challenges with prior art bottom fill nozzles is that beverage contained within the nozzle when closed tends to desaturate, resulting in gas pockets forming within the nozzle between pours. The carbonation level of carbonated beverages is a function of carbon dioxide pressure and temperature, according to the following formula:

$$C = ( P + 1.013 ) * ( 2.7182818284590 {4}^{- 10.73797 + ( \frac{2 617.25}{T + 273.15} )} ) * 10$$

Where C=carbonation in gr/lt; P=pressure of carbon dioxide in bars within a keg/canister/tank; and T=beverage temperature in degrees Celsius. Generally, an increase in temperature or decrease in carbon dioxide pressure will cause carbon dioxide to escape from solution. This desaturation is immediate and will tend to generate excess foaming at the dispensing point. The longer a beverage sits idle in the nozzle (e.g., the longer the time between pours), for example, the more gas will desaturate potentially requiring longer purge times (e.g., amount of time the solenoid valve needs to remain open to sufficiently purge the nozzle). Conversely, the less time a beverage sits idle in the nozzle, the less gas will desaturate (if any), requiring shorter purge times (or no time at all for particularly short idling). Decreasing temperature or increasing carbon dioxide pressure will cause a beverage to absorb carbon dioxide. If a beverage absorbs too much carbon dioxide, this is known as oversaturation. Oversaturation occurs over time, and is not immediate. Once a beverage becomes oversaturated it will tend to generate excess foaming at the dispensing point.

With prior art systems, the temperature of the beverage inside the nozzle tends to warm up towards ambient temperature between pours. With relatively short times between pours (e.g., 1-2 minutes), this warming may be negligible or result in negligible desaturation or foaming, depending on the beverage and the storage and dispensing conditions. With relatively longer times between pours, however, this warming and the associated desaturation may result in undesirable foaming. A casual drink pour is conventionally defined as a pour with excess foam following a certain interval of time between pours. Depending on the type of beverage and storage and dispensing conditions, a casual drink pour may be 15-20 minutes between pours, although in some circumstances it could be shorter or longer. Traditionally, in a casual pour situation with excessive foaming the bartender will open the tap and not accept the initial part of the pour since it's foamy. This initial foamy beer, for example, is sent directly to the drain. As soon as the foamy beer clears, the bartender inserts the cup or other container under the nozzle in order to dispense a proper pour. Depending on the type of beer and beer culture practices, a proper pour can be defined as a filled cup with 1 to 2 fingers of foam at the top.

Depending on the static pressure applied to the beverage, either in the keg or using a beverage pump (e.g., a beer pump), the casual drink can be more a concern (higher pressure) or less a concern (lower pressure). The higher the static pressure, the more stable the beer will be inside the nozzle. The following parameters may determine the impact of casual drink frequency on the pour:
1) Static pressure within the beer/beverage line (higher pressure=lower impact; lower pressure=higher impact)
2) Ambient temperature (higher temperature=higher impact; lower temperature=lower impact)
3) Carbonation level of beer (higher carbonation=higher impact; lower carbonation=lower impact)

The table below includes numbers extrapolated from the Carbonation formula above, and shows the relationship between these 3 parameters.

TABLE
CO₂ content in g/l based on the head pressure and temperature of the beer

| | | head pressure (* 100 kPa) | | | | | | | | | | | | | | | |
|---|---|---|---|---|---|---|---|---|---|---|---|---|---|---|---|---|---|
| | | 0.0 | 0.1 | 0.2 | 0.3 | 0.4 | 0.5 | 0.6 | 0.7 | 0.8 | 0.9 | 1.0 | 1.1 | 1.2 | 1.3 | 1.4 | 1.5 |
| Temperature | −1 | 3.3 | 3.6 | 4.0 | 4.3 | 4.6 | 4.9 | 5.3 | 5.6 | 5.9 | 6.2 | 6.6 | 6.9 | 7.2 | 7.5 | 7.9 | 8.2 |
| (° C.) | 0 | 3.2 | 3.5 | 3.8 | 4.1 | 4.4 | 4.8 | 5.1 | 5.4 | 5.7 | 6.0 | 6.3 | 6.6 | 7.0 | 7.3 | 7.6 | 7.9 |
| | 1 | 3.1 | 3.4 | 3.7 | 4.0 | 4.3 | 4.6 | 4.9 | 5.2 | 5.5 | 5.8 | 6.1 | 6.4 | 6.7 | 7.0 | 7.3 | 7.6 |
| | 2 | 3.0 | 3.3 | 3.6 | 3.9 | 4.1 | 4.4 | 4.7 | 5.0 | 5.3 | 5.6 | 5.9 | 6.2 | 6.5 | 6.8 | 7.1 | 7.4 |
| | 3 | 2.9 | 3.2 | 3.4 | 3.7 | 4.0 | 4.3 | 4.6 | 4.9 | 5.1 | 5.4 | 5.7 | 6.0 | 6.3 | 6.6 | 6.8 | 7.1 |
| | 4 | 2.8 | 3.0 | 3.3 | 3.6 | 3.9 | 4.1 | 4.4 | 4.7 | 5.0 | 5.2 | 5.5 | 5.8 | 6.1 | 6.3 | 6.6 | 6.9 |
| | 5 | 2.7 | 2.9 | 3.2 | 3.5 | 3.7 | 4.0 | 4.3 | 4.5 | 4.8 | 5.1 | 5.3 | 5.6 | 5.9 | 6.1 | 6.4 | 6.7 |
| | 6 | 2.6 | 2.9 | 3.1 | 3.4 | 3.6 | 3.9 | 4.1 | 4.4 | 4.6 | 4.9 | 5.2 | 5.4 | 5.7 | 5.9 | 6.2 | 6.4 |
| | 7 | 2.5 | 2.8 | 3.0 | 3.3 | 3.5 | 3.7 | 4.0 | 4.2 | 4.5 | 4.7 | 5.0 | 5.2 | 5.5 | 5.7 | 6.0 | 6.2 |
| | 8 | 2.4 | 2.7 | 2.9 | 3.1 | 3.4 | 3.6 | 3.9 | 4.1 | 4.3 | 4.6 | 4.8 | 5.1 | 5.3 | 5.5 | 5.8 | 6.0 |
| | 9 | 2.3 | 2.6 | 2.8 | 3.0 | 3.3 | 3.5 | 3.7 | 4.0 | 4.2 | 4.4 | 4.7 | 4.9 | 5.1 | 5.4 | 5.6 | 5.8 |
| | 10 | 2.3 | 2.5 | 2.7 | 2.9 | 3.2 | 3.4 | 3.6 | 3.8 | 4.1 | 4.3 | 4.5 | 4.7 | 5.0 | 5.2 | 5.4 | 5.6 |
| | 11 | 2.2 | 2.4 | 2.6 | 2.9 | 3.1 | 3.3 | 3.5 | 3.7 | 3.9 | 4.2 | 4.4 | 4.6 | 4.8 | 5.0 | 5.2 | 5.5 |
| | 12 | 2.1 | 2.3 | 2.6 | 2.8 | 3.0 | 3.2 | 3.4 | 3.6 | 3.8 | 4.0 | 4.2 | 4.4 | 4.7 | 4.9 | 5.1 | 5.3 |
| | 13 | 2.1 | 2.3 | 2.5 | 2.7 | 2.9 | 3.1 | 3.3 | 3.5 | 3.7 | 3.9 | 4.1 | 4.3 | 4.5 | 4.7 | 4.9 | 5.1 |
| | 14 | 2.0 | 2.2 | 2.4 | 2.6 | 2.8 | 3.0 | 3.2 | 3.4 | 3.6 | 3.8 | 4.0 | 4.2 | 4.4 | 4.6 | 4.8 | 5.0 |
| | 15 | 1.9 | 2.1 | 2.3 | 2.5 | 2.7 | 2.9 | 3.1 | 3.3 | 3.5 | 3.7 | 3.8 | 4.0 | 4.2 | 4.4 | 4.6 | 4.8 |
| | 16 | 1.9 | 2.1 | 2.2 | 2.4 | 2.6 | 2.8 | 3.0 | 3.2 | 3.4 | 3.5 | 3.7 | 3.9 | 4.1 | 4.3 | 4.5 | 4.7 |
| | 17 | 1.8 | 2.0 | 2.2 | 2.4 | 2.5 | 2.7 | 2.9 | 3.1 | 3.3 | 3.4 | 3.6 | 3.8 | 4.0 | 4.2 | 4.3 | 4.5 |
| | 18 | 1.8 | 1.9 | 2.1 | 2.3 | 2.5 | 2.6 | 2.8 | 3.0 | 3.2 | 3.3 | 3.5 | 3.7 | 3.9 | 4.0 | 4.2 | 4.4 |
| | 19 | 1.7 | 1.9 | 2.0 | 2.2 | 2.4 | 2.6 | 2.7 | 2.9 | 3.1 | 3.2 | 3.4 | 3.6 | 3.7 | 3.9 | 4.1 | 4.2 |
| | 20 | 1.7 | 1.8 | 2.0 | 2.1 | 2.3 | 2.5 | 2.6 | 2.8 | 3.0 | 3.1 | 3.3 | 3.5 | 3.6 | 3.8 | 3.9 | 4.1 |
| | 21 | 1.6 | 1.8 | 1.9 | 2.1 | 2.2 | 2.4 | 2.6 | 2.7 | 2.9 | 3.0 | 3.2 | 3.4 | 3.5 | 3.7 | 3.8 | 4.0 |
| | 22 | 1.6 | 1.7 | 1.9 | 2.0 | 2.2 | 2.3 | 2.5 | 2.6 | 2.8 | 2.9 | 3.1 | 3.3 | 3.4 | 3.6 | 3.7 | 3.9 |
| | 23 | 1.5 | 1.7 | 1.8 | 2.0 | 2.1 | 2.3 | 2.4 | 2.6 | 2.7 | 2.9 | 3.0 | 3.2 | 3.3 | 3.5 | 3.6 | 3.8 |
| | 24 | 1.5 | 1.6 | 1.8 | 1.9 | 2.1 | 2.2 | 2.3 | 2.5 | 2.6 | 2.8 | 2.9 | 3.1 | 3.2 | 3.4 | 3.5 | 3.6 |
| | 25 | 1.4 | 1.6 | 1.7 | 1.9 | 2.0 | 2.1 | 2.3 | 2.4 | 2.6 | 2.7 | 2.8 | 3.0 | 3.1 | 3.3 | 3.4 | 3.5 |

| | | head pressure (* 100 kPa) | | | | | | | | | | |
|---|---|---|---|---|---|---|---|---|---|---|---|---|
| | | 1.6 | 1.7 | 1.8 | 1.9 | 2.0 | 2.1 | 2.2 | 2.3 | 2.4 | 2.5 | 2.6 |
| Temperature | −1 | 8.5 | 8.8 | 9.2 | 9.5 | 9.8 | 10.1 | 10.5 | 10.8 | 11.1 | 11.5 | 11.8 |
| (° C.) | 0 | 8.2 | 8.5 | 8.9 | 9.2 | 9.5 | 9.8 | 10.1 | 10.4 | 10.7 | 11.1 | 11.4 |
| | 1 | 7.9 | 8.2 | 8.5 | 8.9 | 9.2 | 9.5 | 9.8 | 10.1 | 10.4 | 10.7 | 11.0 |
| | 2 | 7.7 | 8.0 | 8.3 | 8.5 | 8.8 | 9.1 | 9.4 | 9.7 | 10.0 | 10.3 | 10.6 |
| | 3 | 7.4 | 7.7 | 8.0 | 8.3 | 8.5 | 8.8 | 9.1 | 9.4 | 9.7 | 10.0 | 10.2 |
| | 4 | 7.2 | 7.4 | 7.7 | 8.0 | 8.3 | 8.5 | 8.8 | 9.1 | 9.4 | 9.6 | 9.9 |
| | 5 | 6.9 | 7.2 | 7.5 | 7.7 | 8.0 | 8.2 | 8.5 | 8.8 | 9.0 | 9.3 | 9.6 |
| | 6 | 6.7 | 6.9 | 7.2 | 7.5 | 7.7 | 8.0 | 8.2 | 8.5 | 8.7 | 9.0 | 9.3 |
| | 7 | 6.5 | 6.7 | 7.0 | 7.2 | 7.5 | 7.7 | 8.0 | 8.2 | 8.5 | 8.7 | 8.9 |
| | 8 | 6.3 | 6.5 | 6.7 | 7.0 | 7.2 | 7.5 | 7.7 | 7.9 | 8.2 | 8.4 | 8.7 |
| | 9 | 6.1 | 6.3 | 6.5 | 6.8 | 7.0 | 7.2 | 7.4 | 7.7 | 7.9 | 8.1 | 8.4 |
| | 10 | 5.9 | 6.1 | 6.3 | 6.5 | 6.8 | 7.0 | 7.2 | 7.4 | 7.7 | 7.9 | 8.1 |
| | 11 | 5.7 | 5.9 | 6.1 | 6.3 | 6.5 | 6.8 | 7.0 | 7.2 | 7.4 | 7.6 | 7.8 |
| | 12 | 5.5 | 5.7 | 5.9 | 6.1 | 6.3 | 6.5 | 6.8 | 7.0 | 7.2 | 7.4 | 7.6 |
| | 13 | 5.3 | 5.5 | 5.7 | 5.9 | 6.1 | 6.3 | 6.5 | 6.7 | 6.9 | 7.2 | 7.4 |
| | 14 | 5.2 | 5.4 | 5.5 | 5.7 | 5.9 | 6.1 | 6.3 | 6.5 | 6.7 | 6.9 | 7.1 |
| | 15 | 5.0 | 5.2 | 5.4 | 5.6 | 5.8 | 5.9 | 6.1 | 6.3 | 6.5 | 6.7 | 6.9 |
| | 16 | 4.8 | 5.0 | 5.2 | 5.4 | 5.6 | 5.8 | 5.9 | 6.1 | 6.3 | 6.5 | 6.7 |
| | 17 | 4.7 | 4.9 | 5.0 | 5.2 | 5.4 | 5.6 | 5.8 | 5.9 | 6.1 | 6.3 | 6.5 |
| | 18 | 4.5 | 4.7 | 4.9 | 5.1 | 5.2 | 5.4 | 5.6 | 5.8 | 5.9 | 6.1 | 6.3 |
| | 19 | 4.4 | 4.6 | 4.7 | 4.9 | 5.1 | 5.3 | 5.4 | 5.6 | 5.8 | 5.9 | 6.1 |
| | 20 | 4.3 | 4.4 | 4.6 | 4.8 | 4.9 | 5.1 | 5.3 | 5.4 | 5.6 | 5.7 | 5.9 |
| | 21 | 4.1 | 4.3 | 4.5 | 4.6 | 4.8 | 4.9 | 5.1 | 5.3 | 5.4 | 5.6 | 5.7 |
| | 22 | 4.0 | 4.2 | 4.3 | 4.5 | 4.6 | 4.8 | 4.9 | 5.1 | 5.3 | 5.4 | 5.6 |
| | 23 | 3.9 | 4.1 | 4.2 | 4.4 | 4.5 | 4.7 | 4.8 | 5.0 | 5.1 | 5.3 | 5.4 |
| | 24 | 3.8 | 3.9 | 4.1 | 4.2 | 4.4 | 4.5 | 4.7 | 4.8 | 5.0 | 5.1 | 5.2 |
| | 25 | 3.7 | 3.8 | 4.0 | 4.1 | 4.2 | 4.4 | 4.5 | 4.7 | 4.8 | 4.9 | 5.1 |

British ales 3.0-4.0 g/l
Porter, Stout 3.4-4.6 g/l
Belgian ales 3.8-4.8 g/l
American ales 4.4-5.4 g/l
European lagers 4.4-5.4 g/l
Belgian Lambic 4.8-5.6 g/l
American wheat 5.4-6.6 g/l
German wheat 6.6-9.0 g/l
Source style guidelines: John Palmer (howtobrew.com)

If we consider the example of European lager, this beverage will be in equilibrium state with 4.4 g/l of CO₂ at 20° C. and a static pressure of 1.7 bars (24.7 psi). In this equilibrium state, the beer will not release CO₂ from solution. However, should the temperature of the lager increase by one degree (to 21° C.), for example by sitting idle in a nozzle at room temperature, the beer will tend to desaturate to a new equilibrium at 4.3 g/l CO₂. The remaining 0.1 g/l CO₂ is released from the solution and may remain trapped within the nozzle. This will cause the subsequent pour to occur at a higher initial speed than desired, as the desaturated CO₂ acts as a propellant and creates a foamy pour.

The example illustrated in FIG. 1 addresses these issues in various ways. In one aspect, FIG. 1 provides a mechanism to release gas as it collects towards the top of the nozzle 1. For example, the nozzle 1 may comprise a purge port 6 disposed in a proximal portion (away from the nozzle beverage outlet) of the nozzle. The purge port 6 provides pneumatic communication between the nozzle flow path 4 and ambient to allow purging of entrapped gas from the nozzle 1. The purge port 6 may be in the form of a small orifice or channel extending through the wall of the body portion 3 of the nozzle 1. The purge port 6 may be coupled to a solenoid valve 7, which is operable to selectively open the port 7 and release desaturated gas when desired. The solenoid valve 7 is operable to selectively close the port after a purge. Before a casual drink pour is initiated, the solenoid valve may be activated to open the purge port 6 and purge gas from the nozzle 1.

Nozzle 1 may be purged by manually or automatically by opening the solenoid valve 7 when desired, and for a desired amount of time. Nozzle 1 may be purged based on a variety of parameters, such as time (e.g., amount of time between purge events as well as amount of time the valve remains open during a purge), temperature (e.g., temperature of the beverage within the nozzle as well as ambient temperature), pressure (e.g., beer line static pressure or static pressure within the nozzle), and beverage carbonation levels. Generally, higher carbonated beverages in higher ambient temperature conditions will require more frequent purging (shorter time intervals between purges) and longer purges (more time the solenoid valve 7 is open during a purge). Conversely, lower carbonated beverages in lower ambient temperature conditions will require less frequent purging and shorter purges. By controlling for the parameters that impact desaturation, this aspect allows for more consistency from pour to pour, permitting every beverage to be poured the same way regardless of ambient conditions and casual drink time.

In some examples, a computerized control system (not shown) may be provided to selectively open and close the solenoid valve 7 based on predetermined parameter settings. For example, a control system may be provided to selectively purge the purge port 6 based on two different control parameters for casual drink settings: (1) Nozzle Purge Idle Time; and (2) Nozzle Purge Time. Nozzle Purge Idle Time may be defined in this example as the time that needs to pass between purges in order to activate the purge valve before dispensing. Thus, a Nozzle Purge Idle Time setting of 10 minutes may cause the solenoid valve 7 to open and close before dispensing a pour, where the immediately preceding purge occurred 10 or more minutes prior. Nozzle Purge Time may be defined in this example as the amount of time gas will be purged prior to dispensing a requested pour. It may also be defined as the amount of time that the solenoid valve 7 remains open during a purge. Thus, a setting of 1500 milliseconds may cause the valve 7 to open for 1500 milliseconds and then close prior to dispensing a pour.

Parameter settings may be manually set and controlled by the user. For example, a bartender or manager may manually select certain parameter settings at the beginning of or during a shift, based on the particular carbonation, temperature, and pressure scenarios at hand. Alternatively, the parameter settings may be automatically set or adjusted by the control system, based on real-time measurements of carbonation, temperature, and pressure in the system.

In another aspect, FIG. 1 provides a mechanism to cool the nozzle 1 and beverage contained within the nozzle. This aspect further enables control and minimization of undesirable desaturation and foaming. As illustrated in FIG. 1 (and further in FIG. 2), nozzle cooling unit 8 is disposed in thermal communication with nozzle 1. Nozzle cooling unit 8 is operable to cool at least a portion of the nozzle 1. For example, nozzle cooling unit 8 may comprise a nozzle cooling line having an inlet 8a in communication with an outlet 8b and forming a nozzle cooling fluid conduit therebetween. Inlet 8a and outlet 8b may be adapted to fluidly couple nozzle cooling fluid conduit 8 to a coolant recirculation line comprising a recirculating coolant (described further below). In use, chilled coolant from a recirculating coolant line passes into and through the nozzle cooling line in thermal communication with the nozzle 1, cooling (or maintaining) the temperature of beverage contained within the nozzle 1. As shown in FIGS. 1 and 2, the recirculating coolant line may be disposed in thermal communication with the body portion 3 of nozzle 1, and may be at least partly embedded in body portion 3. By cooling the nozzle 1, nozzle cooling unit 8 may ensure that the beverage is at the desired temperature not only when the beverage enters the nozzle, but also when the beverage eventually is dispensed from the nozzle. This may reduce, or even eliminate, desaturation that could otherwise cause unwanted foaming during dispensing.

FIG. 2 illustrates a top view cross section of dispense nozzle 1. A beverage line (e.g., a beer line as described below) supplies nozzle 1 with beverage. As illustrated in FIG. 2, the nozzle cooling line may be at least partly embedded within the body portion 3 of nozzle 1. A coolant recirculation line (described below) supplies the nozzle cooling line with coolant to cool the nozzle 1 and the beverage contained therein. As explained below, the coolant recirculation line and beverage line may be kept in thermal contact to ensure beverage is delivered to the nozzle at a desired temperature. The nozzle cooling line may be kept in substantial thermal contact with the beverage line as the nozzle cooling line engages the nozzle 1.

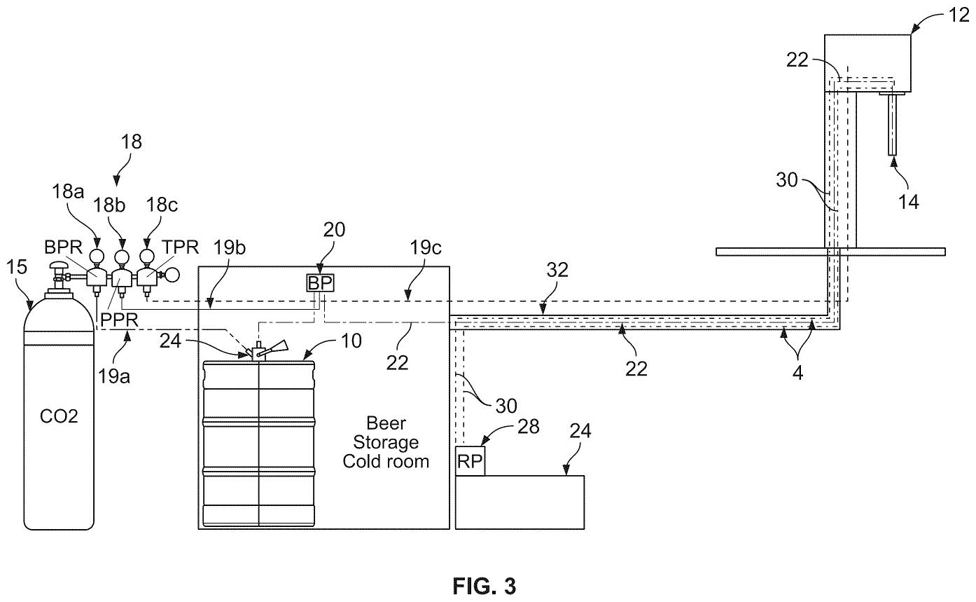

FIG. 3 illustrates an example of a beverage dispensing system (e.g., a beer dispensing system) that may be used with a nozzle according to this disclosure. The system is a simple single product installation including a keg 10 stored in a refrigerated cold storage room, for example a refrigerated storage room in the basement of a bar. The beverage contained in the keg 10 is dispensed remotely via a dispense tower 12. The distance between the cold storage room and the dispense tower 12 may be tens and even hundreds of feet, depending on the installation.

The tower may include one or more nozzles 14, such as a nozzle described herein. A gas cylinder 16 (e.g., comprising carbon dioxide) is provided along with a pressure regulator 18. Pressure regulator 18 regulates the flow of gas from the cylinder 16 to various components. Regulator 18 comprises a beer pressure regulator (BPR) 18a for regulating flow of gas to the keg 10 via pneumatic line 19a, a pump pressure regulator (PPR) 18b for regulating flow of gas with beer pump 20 via pneumatic line 19b, and a tower pressure regulator (TPR) 18c for regulating flow of gas with the tower 12 via pneumatic line 19c. In some examples, multiple beer pressure regulators and beer pumps may be provided, for example in systems comprising multiple dispensers for dispensing beverages from multiple kegs with different beverages.

Beer pressure may be set by the beer pressure regulator 18a (BPR), according to the carbonation formula. Beer is propelled at higher pressure and flow rate using a beer pump 20. Beer pump 20 is set by pump pressure regulator (PPR) 18b. Refrigerated beer is extracted from the keg 10 and travels to the tower 12 within a beer line 22. Beer line 22 is coupled to keg via coupler 24. Coupler 24 may also couple keg 10 to gas cylinder 16. In the example shown in FIG. 3, the beer line travels out of the refrigerated cold storage room a distance before it arrives at the tower 10 and nozzle 14. This distance may be tens, or even hundreds of feet depending on the setup.

To be able to transport the beer long distances beyond the cold storage unit as is generally required in traditional installations, beer pumps or mixed gas of carbon dioxide and nitrogen may be used. Beer pump 20 may be installed generally proximate the keg 10, for example within the same cold storage room. The beer pump 20 is operable to increase the pressure of the beer within the beer line 22 without causing oversaturation, since the pressure in the keg/container stays constant. The higher the pump pressure is from the CO₂ balance pressure in the keg, the more stable the beer will be along the beer line. In the case of mixed gas, a blend of CO₂ and Nitrogen (to specific percentage as a function of beer carbonation and storage temperature) may be used to pressurize the keg 10. Inert Nitrogen gas serves as an additional propellent.

In some examples, the beer in the keg 10 may be maintained at serving/drinking temperature in the cold storage room, with no additional cooling provided after the beer travels out of the cold storage room to the tower 12. In other examples, a cooling unit 26 may be provided to cool the beer within the beer line after it exits the cold storage room, while it travels to the tower 12 and the nozzle 14. For example, a chiller with a liquid coolant may be provided (e.g., an ice bank chiller), with a recirculation pump 28 to circulate chilled coolant through a coolant recirculation line 30. The coolant recirculation line 30 may then be placed in thermal contact with the beer line 22 as it travels towards the tower 12. This may be accomplished, for example, by bundling and insulating the beer line 22 and recirculation line 30 in a so-called trunk/python line 32. A python/trunk line 32 is an insulated bundle of tubes that arranges beer line tubes in thermal contact with a cooling recirculation line. Generally, trunk/python 32 lines may extend up to hundreds of feet in length, depending on the dispensing system and the location of the keg relative to the dispensing tower.

The coolant used to cool the beer line 22 may be water. In other examples, the coolant may be a mixture of water and glycol. Water/glycol mixtures are particularly suitable in higher risk foaming situations, for example with highly carbonated beverages, or in applications requiring long continuous pour (e.g., pitchers). In these situations, the coolant may comprise a glycol mix with a freezing point preferably no lower than 28° F.

When used in combination with nozzle 1, described above, the beer line 22 may be fluidly coupled in the tower 12 to the beverage inlet of the nozzle 1 to permit refrigerated beverage to enter the nozzle. The coolant recirculation line 30 may be fluidly coupled to the nozzle cooling fluid conduit 8 to permit cooling of beverage while it is contained within the nozzle 1.

The nozzles described herein (above and below) may be used in or with beverage dispensing systems other than those of the type illustrated in FIG. 3. These nozzles may be used, for example, in or with a keg cooling unit as described in U.S. Provisional Application No. 63/636,656, incorporated by reference herein.

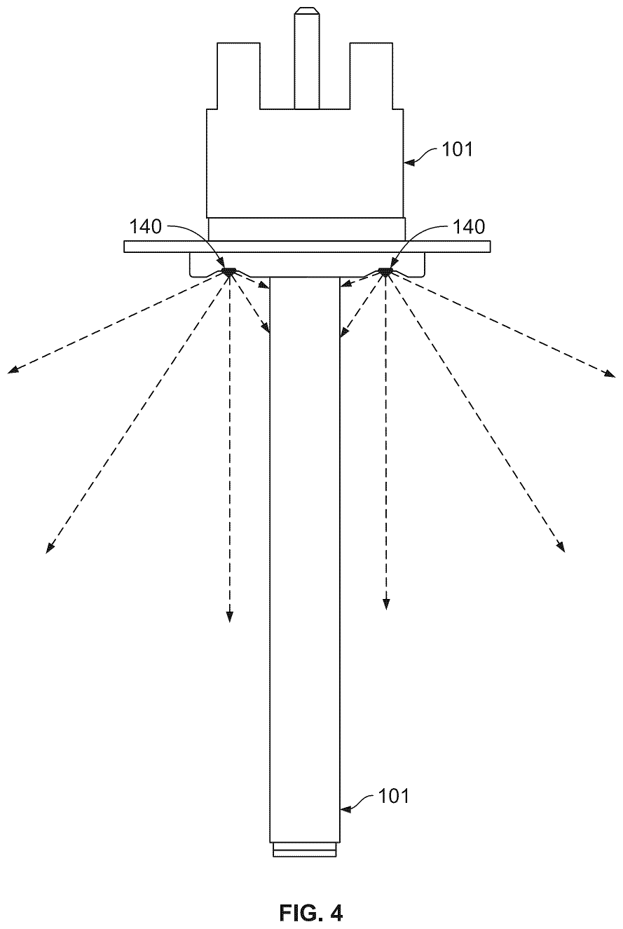

FIG. 4 illustrates a nozzle 101 operable for bottom-filling applications. Nozzle 101 may comprise one or more of the features described above with respect to nozzle 1 and FIGS. 1 and 2. As illustrated in FIG. 4, nozzle 101 comprises antimicrobial element 140. Antimicrobial element 140 is operable to clean and sanitize beverage-contacting surfaces of the nozzle 101. This aspect is useful in examples where nozzles are used in a consumer or commercial setting, for example in restaurants, bars, or home applications for filling cups, mugs, glasses, pitchers, and the like. This and other aspects described above and below in this application are also useful in examples where nozzles are used in industrial settings, for example in an industrial packaging facility (e.g., with respect to nozzles for bottom-filling of containers such as cans or bottles). This aspect is also useful in examples where the nozzles are not intended or used for bottom-filling, but where the nozzles have surfaces suitable for antimicrobial cleaning and sanitizing in accordance with this disclosure.

Antimicrobial element 140 may comprise one or more antimicrobial LED lights. FIG. 4 illustrates an example including a plurality of antimicrobial LEDs 140. The LEDs are selected, positioned, and operable to expose beverage-contacting surfaces of the nozzle to sanitizing antimicrobial light. In some examples, the LEDs are capable of providing antimicrobial light radiation up to approximately 15 inches away from the source. In the example shown, a plurality of LED lights may be disposed at a proximal base of the nozzle (away from the beverage outlet) facing downwards (in the direction of the ground or floor in use), and arranged radially about a periphery of the nozzle 101. The LEDs emit light radially outwardly, as illustrated by the dashed arrows in FIG. 4. The LEDs may be arranged equidistantly about the periphery of the nozzle 101. Other arrangements are also contemplated to ensure beverage-contacting surfaces of the nozzle 101 are exposed to an effective amount of antimicrobial light during use.

Examples of LEDs that may be used with the nozzle 101 illustrated in FIG. 4 include UV-free antimicrobial devices presently available from Vyv, Inc. U.S. Pat. No. 11,541,135 to Vyv, Inc. discusses processes, systems, and apparatus for visible light disinfection, and is incorporated by reference herein.

Suitable antimicrobial LEDs may include devices emitting antimicrobial light within the visible light spectrum, and preferably not in the UV light spectrum, permitting continuous and unrestricted use around humans. Suitable LEDs are preferably operable to kill a variety of viruses and bacteria, including SARS-CoV-2, MRSA, E. coli Bacteria, and other bacteria, fungi, yeast, and mold. They are also operable for preventing build-up of undesirable films (e.g., films originating from bacteria or mold, including Aspergillus mold growth).

UV-free LED technology is measured at wavelengths of approximately 380-750 nm, outside the UV light spectrum. In some examples, LEDs 140 may emit non-UV light within a wavelength range of 380-420 nm, at a collective intensity sufficient to initiate inactivity of microorganisms and disinfect the beverage-contacting surfaces of the nozzle 101. In some examples, LEDs 140 may emit non-UV light within a wavelength range of 490-660 nm, at a collective intensity sufficient to initiate inactivity of microorganisms and disinfect the beverage-contacting surfaces of the nozzle 101. In some examples, LEDs 140 may collectively emit non-UV light within a wavelength range of 380-420 nm and 490-660 nm, at a collective intensity sufficient to initiate inactivity of microorganisms and disinfect the beverage-contacting surfaces of the nozzle 101.

Certain beverages may be adversely susceptible to light. Beer, for example, is known to degrade when exposed to light, resulting in so-called “light-struck” or “skunked” beer. Direct light contact may lead to breakdown of beer components that result in a “skunky” aroma.” In order to prevent this phenomenon, the nozzle 101 is preferably operable so that LEDs 140 do not emit light during a pour. Conversely, the nozzle 101 may be operable so that LEDs 140 emit light only when a pour is not active or imminent. In some examples, the LEDs may be operable to turn on between pour events, and to turn off during pour events. A control system (not shown) may be provided in combination with light or video sensors to identify when a beverage is, or likely is, disposed within a predetermined dispensing area of the nozzle. Such a system may be operable to turn on the LEDs 140 when no container is disposed within the predetermined dispensing area. Conversely, such a system may be operable to turn off the LEDs 140 when a container is detected within the predetermined dispensing area.

In each of the foregoing examples, the nozzle may be opened and a pour dispensed using switch lever activation, or other types of mechanical switch activation as known in the art. Examples of activation devices and techniques that may be useful for opening nozzles and dispensing a pour are found in U.S. Pat. No. 10,662,053 (incorporated by reference herein), and include switch levers and micro-switches configured for one-handed and/or two-handed operation. For example, the nozzles described in this application could be activated using a mechanical switch lever operatively coupled to a micro switch, such that physically manipulating the switch lever activates the micro switch causing the nozzle to open and/or close.

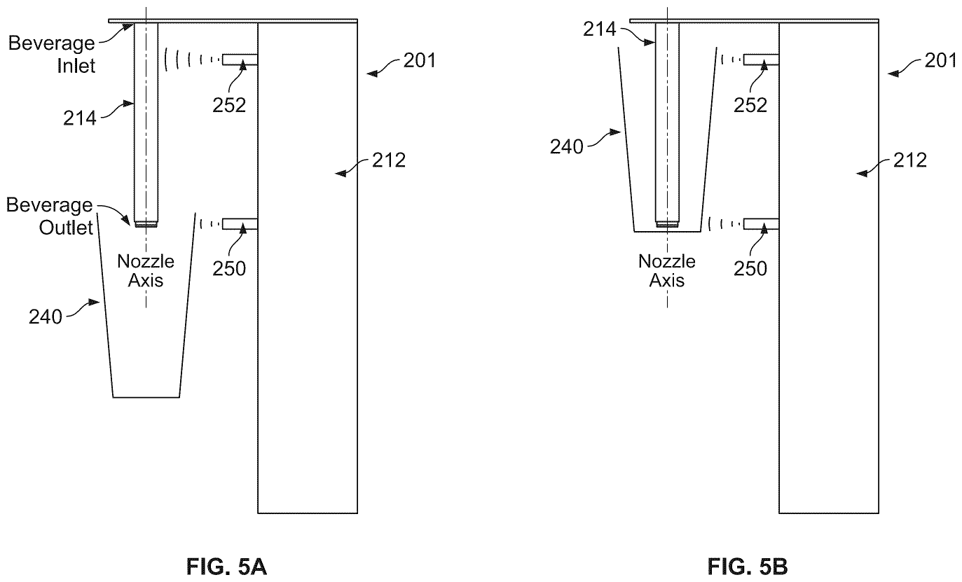

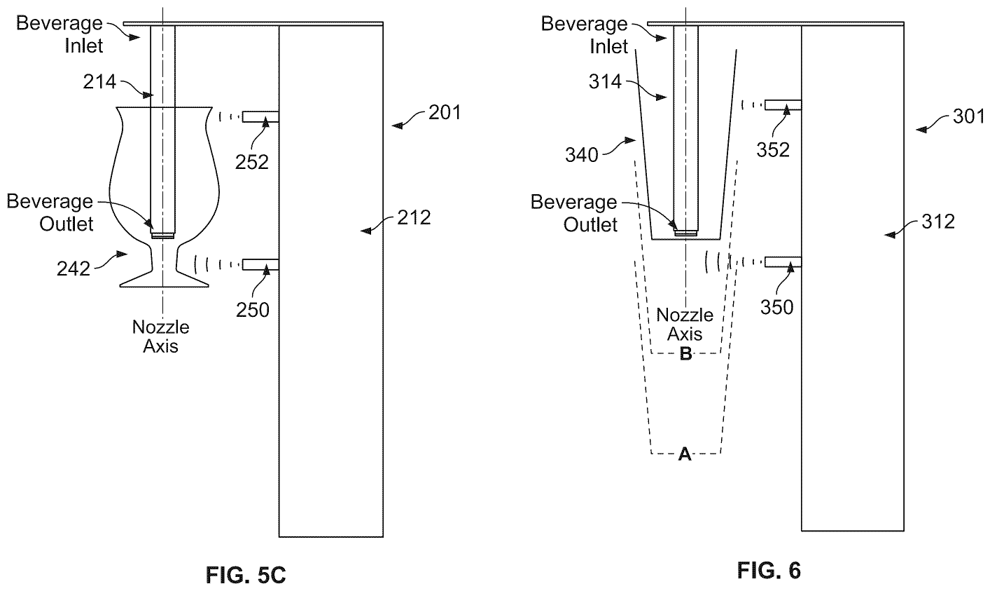

FIGS. 5-8 illustrate alternate solutions for activating a pour. In these examples, electronic sensors are used to detect the presence and proper positioning of a container ready to receive a pour with a bottom fill type nozzle. The sensors are coupled with the nozzle, either directly or indirectly connected via intermediate components of the beverage dispensing system. The sensors may be positioned at different angles relative to the nozzle, as shown in these figures and described below. For example, one or more sensors may be positioned perpendicular to the axis of the nozzle, parallel to the axis of the nozzle, or at any angle relative to the axis of the nozzle suitable in a particular use. The sensors are preferably mounted and positioned in such a way that they can be easily configured for different container characteristics, including types, materials, and sizes.

FIGS. 5A-5C illustrate an example of a beverage dispensing system comprising a beverage dispenser 201 with electronic pour sensing and activation. Beverage dispenser 201 comprises a tower 212 and an elongate nozzle 214 having a beverage inlet end in fluid communication with a beverage outlet end to define a beverage flow path therebetween. Nozzle 214 is operable for bottom-filling applications, and defines a nozzle axis (illustrated by dashed line). Nozzle 214 has an open configuration operable to dispense a beverage through the nozzle, and a closed configuration operable to prevent dispensing through the nozzle. Nozzle 214 may comprise one or more of the features described above with respect to the nozzles in FIGS. 1, 2, and 4.

Beverage dispenser 201 comprises a plurality of sensors 250, 252, each operable to detect a container presence (e.g., presence of container 240 or container 242) within its sensing region, at a location relative to the nozzle. Sensors 250, 252 are coupled with the nozzle (e.g., via tower 212). Sensor 250 is positioned and operable to detect a container presence at a location relative to the nozzle adjacent the beverage outlet end (in this example, at a location generally at the beverage outlet end of the nozzle). Sensor 252 is positioned and operable to detect a container presence at a location along a length of the nozzle between the beverage outlet and inlet ends. A controller (not shown) may be provided and configured to open the nozzle and dispense a pour when the sensors detect the presence and proper positioning of a container ready to receive a pour.

In FIG. 5A, a container 240 (e.g., a cup) is shown in a position identified as unsuitable for receiving a pour. For example, nozzle 214 is positioned with the nozzle beverage outlet adjacent the top of the container 240, rather than the bottom of the container interior. Dispensing a pour in this configuration may lead to undesirable splashing and foaming. A portion of the container 240 is positioned in the sensing region of sensor 250, between sensor 250 and nozzle 214. As such, sensor 250 senses the presence of container 240. Container 240 is outside the sensing region of sensor 250, however, and therefore sensor 250 does not detect the presence of container 240. A controller (not shown) may register output from sensors 250, 252 at this point indicating the presence of container 240 at the sensing region of sensor 250, but not at the sensing region of sensor 252.

In FIG. 5B, container 240 is shown moved into a position identified as suitable for receiving a pour. Nozzle 214 is positioned within the beverage container with the beverage outlet adjacent the bottom of the container interior. In this position, a portion of the container 240 is positioned in the sensing region of sensor 250, between sensor 250 and nozzle 214. In addition, a portion of the container 240 is positioned in the sensing region of sensor 252, between sensor 252 and nozzle 214. As such, both sensors 250, 252 sense the presence of container 240. The controller (not shown) may register output from sensors 250, 252 at this point indicating the presence of container 240 at the sensing regions of both sensors 250, 252. As this position is identified as suitable for receiving a pour in this example, the controller may be configured to open the nozzle and dispense a pour.

Similarly, in FIG. 5C, container 242 (e.g., a stemmed glass or cup) is shown moved into a position identified as suitable for receiving a pour. Nozzle 214 is positioned within the beverage container with the beverage outlet adjacent the bottom of the container interior. In this position, a portion of the container 242 is positioned in the sensing region of sensor 250, between sensor 250 and nozzle 214. In addition, a portion of the container 242 (stem region) is positioned in the sensing region of sensor 252, between sensor 252 and nozzle 214. As such, both sensors 250, 252 sense the presence of container 242. The controller (not shown) may register output from sensors 250, 252 at this point indicating the presence of container 242 at the sensing regions of both sensors 250, 252. As this position is identified as suitable for receiving a pour in this example, the controller may be configured to open the nozzle and dispense a pour.

In some examples, the controller may be configured and operable to open the nozzle and dispense a pour immediately once both sensors 250, 252 detect the presence of the container. In some examples, the controller may be configured and operable to open the nozzle and dispense a pour only when both sensors 250, 252 detect the presence of the container for a predetermined amount of time. In some examples, sensor 250 will not be required and a pour may be initiated using sensor 252 by itself. Sensor 250 may be used to filter out unwanted or false triggers should an object be placed inadvertently in front of this sensor. Thus, as shown in FIG. 6 for example, a controller may be configured to open the nozzle and dispense a pour when both sensors have detected a container presence, regardless of whether the bottom sensor is detecting a container presence at the time the pour is initiated.

In order to prevent inadvertent dispensing, the controller may be configured to open the nozzle and dispense a pour on the occurrence of a predetermined sensing event or series of events. In one example, the controller may be configured to open the nozzle and dispense a pour in the following scenario: (a) first, sensor 250 detects a container presence; (b) sensor 252 detects a container presence; (c) both sensors detect a container presence. In this example, the pour will start when each of the above elements has been satisfied. This example may be preferable for cups/glasses with a stem. Depending on its placement and positioning of its sensing region in relation to the beverage outlet end of the nozzle, sensor 252 may determine when the outlet end of the nozzle is at the bottom of the cup interior and ready for a pour. In some examples, the controller may be configured and operable to open the nozzle and dispense a pour only when both sensors 250, 252 detect the presence of container 240 for a predetermined amount of time

The following is an example of a binary sequence of sensing events that may be particularly useful with a stem cup, where sensor detection=“1,” and no sensor detection=“0”:

| Pour status | Sensor 250 | Sensor 252 |
|---|---|---|
| No | 0 | 0 |
| No | 1 | 0 |
| Yes | 1 | 1 |

FIG. 6 illustrates an example of a beverage dispensing system comprising a beverage dispenser 301 with electronic pour sensing and activation. Beverage dispenser 301 comprises a tower 312 and an elongate nozzle 314 having a beverage inlet end in fluid communication with a beverage outlet end to define a beverage flow path therebetween. Nozzle 314 is operable for bottom-filling applications, and defines a nozzle axis (illustrated by dashed line). Nozzle 314 has an open configuration operable to dispense a beverage through the nozzle, and a closed configuration operable to prevent dispensing through the nozzle. Nozzle 314 may comprise one or more of the features described above with respect to the nozzles in FIGS. 1, 2, 4, and 5.

Dispenser 301 comprises a plurality of sensors 350, 352, each operable to detect a container presence (e.g., container 340) within its sensing region, at a location relative to the nozzle. Sensors 350, 352 are coupled with the nozzle (e.g., via tower 312). Sensor 350 is positioned and operable to detect a container presence at a location relative to the nozzle adjacent the beverage outlet end (in this example, at a location along the nozzle axis distal to the beverage outlet end (e.g., 0.5 inch distal, 1.0 inch, or several inches distal). Sensor 352 is positioned and operable to detect a container presence at a location relative to the nozzle, along a length of the nozzle between the beverage outlet and inlet ends.

In FIG. 6, a container 340 (e.g., a cup) is shown in a position identified as suitable for receiving a pour. Nozzle 314 is positioned within the beverage container with the beverage outlet adjacent the bottom of the container interior. In this position, a portion of the container 340 is positioned in the sensing region of sensor 352, between sensor 352 and nozzle 314. Container 340 is outside the sensing region of sensor 350, however, and therefore sensor 350 does not detect the presence of container 340. A controller (not shown) may register output from sensors 350, 352 at this point indicating the presence of container 340 at the sensing region of sensor 352, but not at the sensing region of sensor 350. As this position is identified as suitable for receiving a pour in this example, the controller may be configured to open the nozzle and dispense a pour.

In some examples, the controller may be configured to open the nozzle and dispense a pour in the following scenario: (a) first, sensor 350 detects a container presence (e.g., container position “A” in FIG. 6); (b) sensor 352 detects a container presence (e.g., container position “B” in FIG. 6); (c) sensor 352 continues to detect a container presence but sensor 350 does not detect a container presence (e.g., position of container 340 in FIG. 6). In this example, the pour will start when each of the above elements has been satisfied. This example may be used to ensure that a container has been placed all the way up the nozzle. The bottom sensor 350 will determine when the nozzle is at the bottom of the container interior (e.g., when the bottom exterior of a smaller container clears sensor 350 and is no longer detected), and the precise positioning of the top sensor may be less critical. In some examples, the controller may be configured and operable to open the nozzle and dispense a pour only when element “(c)” is satisfied for a predetermined amount of time, as described above.

The following is an example of a binary sequence of sensing events that may be particularly useful with a flat bottom cup, where sensor detection=“1,” and no sensor detection=“0”:

| Pour status | Sensor 250 | Sensor 252 |
|---|---|---|
| No | 0 | 0 |
| No | 1 | 0 |
| No | 1 | 1 |
| Yes | 0 | 1 |

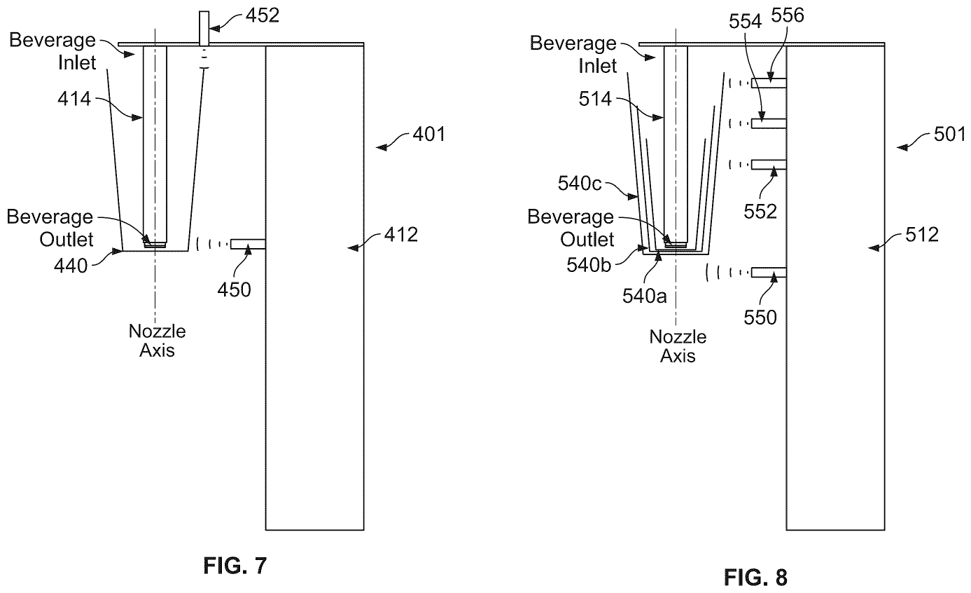

FIG. 7 illustrates an example of a beverage dispensing system comprising a beverage dispenser 401 with electronic pour sensing and activation. Beverage dispenser 401 comprises a tower 412 and an elongate nozzle 414 having a beverage inlet end in fluid communication with a beverage outlet end to define a beverage flow path therebetween. Nozzle 414 is operable for bottom-filling applications, and defines a nozzle axis (illustrated by dashed line). Nozzle 414 has an open configuration operable to dispense a beverage through the nozzle, and a closed configuration operable to prevent dispensing through the nozzle. Nozzle 414 may comprise one or more of the features described above with respect to the nozzles in FIGS. 1, 2, 4, 5, and 6.

Dispenser 401 comprises a plurality of sensors 450, 452, each operable to detect a container presence (e.g., container 440) within its sensing region, at a location relative to the nozzle. Sensors 450, 452 are coupled with the nozzle (e.g., via tower 412). Sensor 450 is positioned and operable to detect a container presence at a location relative to the nozzle adjacent the beverage outlet end (in this example, at a location generally at the beverage outlet end of the nozzle). Sensor 452 is positioned and operable to detect a container presence at a location relative to the nozzle, adjacent the beverage inlet end of the nozzle 414. In this example, sensor 452 is positioned generally parallel to the axis of the nozzle, whereas sensor 450 is positioned generally perpendicular to the axis of the nozzle. A controller (not shown) may be provided and configured to open the nozzle and dispense a pour when the sensors detect the presence and proper positioning of a container ready to receive a pour, as described above.

FIG. 8 illustrates an example of a beverage dispensing system comprising a beverage dispenser 501 with electronic pour sensing and activation. Beverage dispenser 501 comprises a tower 512 and an elongate nozzle 514 having a beverage inlet end in fluid communication with a beverage outlet end to define a beverage flow path therebetween. Nozzle 514 is operable for bottom-filling applications, and defines a nozzle axis (illustrated by dashed line). Nozzle 514 has an open configuration operable to dispense a beverage through the nozzle, and a closed configuration operable to prevent dispensing through the nozzle. Nozzle 514 may comprise one or more of the features described above with respect to the nozzles in FIGS. 1, 2, and 4-7.

Dispenser 501 comprises a plurality of sensors 550, 552, 554, 556, each operable to detect a container presence (e.g., container 540a, 540b, or 540c) within its sensing region, at a location relative to the nozzle. Sensors 550, 552, 554, 556 are coupled with the nozzle (e.g., via tower 512). Sensor 550 is positioned and operable to detect a container presence at a location relative to the nozzle adjacent the beverage outlet end (in this example, at a location along the nozzle axis distal to the beverage outlet end). Sensor 552 is positioned and operable to detect a container presence at a location relative to the nozzle, along a length of the nozzle between the beverage outlet and inlet ends. Sensor 554 is positioned and operable to detect a container presence at a location relative to the nozzle, along a length of the nozzle between the beverage inlet end and sensor 552. Sensor 556 is positioned and operable to detect a container presence at a location relative to the nozzle, along a length of the nozzle between the beverage inlet end and sensor 554. A controller (not shown) may be provided and configured to open the nozzle and dispense a pour when the sensors detect the presence and proper positioning of a container ready to receive a pour, as described above.

In this example, the sensors 550, 552, 554 556 may be used not only to detect the presence of a container in a proper position for a pour, but also to detect and distinguish between different container sizes. Thus, a controller (not shown) may be provided in combination with the sensors to open the nozzle and dispense pours of varying sizes or volumes, depending on the size of the container detected.

FIG. 8 illustrates three container sizes (although examples suitable for fewer or greater number of sizes are contemplated): a relatively small container 540a, a relatively large container 540c, and an intermediate-sized (medium) container 540b. Each of these containers is illustrated in a position identified as suitable for receiving a pour. The sensors 550, 552, 554, 556 are arranged relative to one another and the nozzle 514 based on the relative container sizes, so that each container size is associated with a different set of sensors in its pour-receiving configuration. In this example, sensor 550 acts in combination with sensors 552, 554, and 556 as a trigger, registering to the controller when to initiate a pour and what size pour to initiate.

For example, the sensors may be arranged as shown in FIG. 8 such that sensor 550 will be the first sensor to detect an approaching container regardless of its size, followed by detection by one or more of the other sensors 552, 554, 556. In addition, the sensors may be arranged as shown in FIG. 8 such that sensor 550 stops detecting each container 540a, 540b, 540c when it is in its respective pour position. Thus, sensor 550 may effectively “trigger” a pour to the controller when it no longer detects a container at the same time the container is detected by one or more of the other sensors 552, 554, 556. in the example shown in FIG. 8:
the relatively small container 540a will be sensed only by sensor 552 when sensor 550 no longer senses container 540a, triggering a relatively small-sized pour;
the intermediate sized container 540b will be sensed by sensors 552 and 554 (but not sensor 556) when sensor 550 no longer senses container 540b, triggering a medium-sized pour; and
the relatively large container 540c will be sensed by sensors 552, 554, and 556 when sensor 550 no longer senses container 540c, triggering a relatively large-sized pour.

The sensors described above may be configured and operable to detect a particular characteristic or characteristics of a container identified as suitable for receiving a pour, to the exclusion of containers lacking those particular characteristics. In this way, the beverage dispensing system may be configured and operable to dispense a pour for containers having certain predetermined characteristics, but not for other containers lacking those predetermined characteristics. For example, sensors may be configured and operable to detect only the presence of containers of certain predefined sizes, shapes, markings, and the like. A controller may be provided in combination with such sensors to dispense pours only when containers matching those certain predefined sizes, shapes, markings, etc. are detected. In some examples, sensors may be selected to detect the presence of containers comprising metal (e.g., aluminum or steel), but not plastic containers lacking metal. A controller may be provided in combination with such sensors to dispense pours only when certain metal-containing containers are detected (e.g., any metal-containing container, or only aluminum-containing containers). In some examples, sensors may be configured and operable in combination with a controller to detect the size of a container positioned to receive a pour and to dispense a pour accordingly—for example, relatively small pours when relatively small containers are detected and relatively large pours when relatively large containers are detected. In these ways, beverage dispensing systems may be custom tailored to a user's specifications.

Some examples according to this description may utilize induction proximity sensors operable to detect ferrous (e.g., steel) and/or non-ferrous (e.g., aluminum and copper) target presences within the proximity of the sensor, without requiring physical contact between the sensor and the target. Some examples may utilize capacitive proximity sensors operable to detect targets such as plastic objects within the proximity of the sensor, without requiring physical contact between the sensor and the target. Some examples may utilize optical sensors operable to detect targets within the proximity sensor, without requiring physical contact between the sensor and the target. The type and number of sensors will be selected based on the particular requirements and desired output, as would be understood by a person of ordinary skill in the art in view of this disclosure.

The following are example claims:

1. A beverage dispenser comprising: a nozzle comprising a beverage inlet in fluid communication with a beverage outlet to define a beverage flow path, an open configuration operable to dispense a beverage from the nozzle, and a closed configuration operable to store a volume of beverage within the nozzle; and a means for selectively purging gas from the nozzle in the closed configuration.

2. The dispenser of claim 1, where the means for selectively purging comprises a conduit having a conduit inlet in pneumatic communication with a conduit outlet to form a pneumatic flow path, and where the conduit inlet is in pneumatic communication with the beverage flow path, and the conduit outlet is in pneumatic communication with ambient.

3. The dispenser of claim 2, where the conduit comprises a channel disposed in the nozzle and providing pneumatic communication between the beverage flow path and ambient.

4. The dispenser of claim 2, where the means for selectively purging comprises a valve operable to selectively open and close the pneumatic flow path.

5. The dispenser of claim 1, where the means for selectively purging comprises a purge port providing pneumatic communication between the beverage flow path and ambient.

6. The dispenser of claim 5, where the means for selectively purging comprises a valve operable to selectively open and close the purge port.

7. The dispenser of claim 6, where the valve is manually operable to selectively open and close the purge port.

8. The dispenser of claim 6, comprising a control system for selectively opening and closing the purge port.

9. The dispenser of claim 8, where the control system is configured to selectively open and close the purge port based on a predetermined parameter setting.

10. The dispenser of claim 10, where the parameter setting is selected from: nozzle purge time, nozzle idle purge time, beverage carbonation level, ambient temperature, beverage temperature, and beverage static pressure.

11. The dispenser of claim 1, comprising a cooling mechanism in thermal communication with the nozzle.

12. The dispenser of claim 1, comprising a cooling mechanism in thermal communication with the beverage flow path.

13. The dispenser of claim 1, comprising a nozzle cooling line having an inlet in fluid communication with an outlet to define a coolant flow path, where the nozzle cooling line is configured to receive refrigerated coolant in the coolant flow path, and where the coolant flow path is in thermal communication with the beverage flow path.

14. The dispenser of claim 13, where the coolant line is at least partly embedded in the nozzle.

15. The dispenser of claim 13, where the coolant line is in thermal communication with the nozzle between the beverage inlet and the beverage outlet.

16. The dispenser of claim 13, where the coolant line is in contact with the nozzle between the beverage inlet and the beverage outlet.

17. The dispenser of claim 1, comprising an antimicrobial element operable to sanitize a surface of the nozzle.

18. The dispenser of claim 17, where the surface is a beverage-contacting surface of the nozzle.

19. The dispenser of claim 17, where the antimicrobial element comprises an antimicrobial light element.

20. The dispenser of claim 19, where the antimicrobial light element comprises an UV-free antimicrobial LED.

21. The dispenser of claim 1, where the nozzle is a bottom-filling nozzle.

22. The dispenser of claim 1, where the nozzle comprises an elongate actuator rod portion slidingly disposed within a bore of an elongate body portion, where the actuator rod portion and the body portion cooperate to form the beverage flow path.

23. A beverage dispenser comprising: a nozzle comprising a beverage inlet in fluid communication with a beverage outlet to define a beverage flow path, an open configuration operable to dispense a beverage from the nozzle, and a closed configuration operable to store a volume of beverage within the nozzle; and a pneumatic conduit having a conduit inlet in pneumatic communication with a conduit outlet to form a pneumatic flow path, where the conduit inlet is in pneumatic communication with the beverage flow path, and the conduit outlet is in pneumatic communication with ambient.

24. The dispenser of claim 23, where the conduit comprises a channel disposed in the nozzle and providing pneumatic communication between the beverage flow path and ambient.

25. The dispenser of claim 24, where the channel is positioned at the beverage inlet end portion of the nozzle.

26. The dispenser of claim 23, comprising a valve operable to selectively open and close the pneumatic flow path.

27. The dispenser of claim 26, where the valve is manually operable to selectively open and close the pneumatic flow path.

28. The dispenser of claim 23, comprising a control system for selectively opening and closing the pneumatic flow path.

29. The dispenser of claim 28, where the control system is configured to selectively open and close the pneumatic flow path based on a predetermined parameter setting.

30. The dispenser of claim 29, where the parameter setting is selected from: nozzle purge time, nozzle purge idle time, beverage carbonation level, ambient temperature, beverage temperature, and beverage static pressure.

31. The dispenser of claim 23, comprising a cooling mechanism in thermal communication with the nozzle.

32. The dispenser of claim 23, comprising a cooling mechanism in thermal communication with the beverage flow path.

33. The dispenser of claim 23, comprising a nozzle cooling line having an inlet in fluid communication with an outlet to define a coolant flow path, where the nozzle cooling line is configured to receive refrigerated coolant in the coolant flow path, and where the coolant flow path is in thermal communication with the beverage flow path.

34. The dispenser of claim 33, where the coolant line is at least partly embedded in the nozzle.

35. The dispenser of claim 33, where the coolant line is in thermal communication with the nozzle between the beverage inlet and the beverage outlet.

36. The dispenser of claim 33, where the coolant line is in contact with the nozzle between the beverage inlet and the beverage outlet.

37. The dispenser of claim 23, comprising an antimicrobial element operable to sanitize a surface of the nozzle.

38. The dispenser of claim 37, where the surface is a beverage-contacting surface of the nozzle.

39. The dispenser of claim 37, where the antimicrobial element comprises an antimicrobial light element.

40. The dispenser of claim 39, where the antimicrobial light element comprises an UV-free antimicrobial LED.

41. The dispenser of claim 23, where the nozzle is a bottom-filling nozzle.

42. The dispenser of claim 23, where the nozzle comprises an elongate actuator rod portion slidingly disposed within a bore of an elongate body portion, where the actuator rod portion and the body portion cooperate to form the beverage flow path.

43. A beverage dispenser comprising: a nozzle comprising a beverage inlet in fluid communication with a beverage outlet to define a beverage flow path, an open configuration operable to dispense a beverage from the nozzle, and a closed configuration operable to store a volume of beverage within the nozzle; a nozzle cooling line having an inlet in fluid communication with an outlet to define a coolant flow path, where the nozzle cooling line is configured to receive refrigerated coolant in the coolant flow path, and where the coolant flow path is in thermal communication with the beverage flow path.

44. The dispenser of claim 43, where the coolant line is at least partly embedded in the nozzle.

45. The dispenser of claim 43, where the coolant line is in thermal communication with the nozzle between the beverage inlet and the beverage outlet.

46. The dispenser of claim 43, where the coolant line is in contact with the nozzle between the beverage inlet and the beverage outlet.

47. The dispenser of claim 43, further comprising a means for selectively purging gas from the nozzle in the closed configuration.

48. The dispenser of claim 43, comprising an antimicrobial element operable to sanitize a surface of the nozzle.

49. The dispenser of claim 43, comprising an antimicrobial light element operable to sanitize a surface of the nozzle.

50. The dispenser of claim 43, where the nozzle is a bottom-filling nozzle.

51. The dispenser of claim 43, where the nozzle comprises an elongate actuator rod portion slidingly disposed within a bore of an elongate body portion, where the actuator rod portion and the body portion cooperate to form the beverage flow path.

52. A beverage dispenser comprising: a nozzle comprising a beverage inlet in fluid communication with a beverage outlet to define a beverage flow path; an antimicrobial light element coupled to the nozzle and positioned to expose a surface of the nozzle to antimicrobial light radiation at an intensity sufficient to initiate inactivity of microorganisms and disinfect the surface of the nozzle.

53. The dispenser of claim 52, where the antimicrobial light element comprises an antimicrobial LED.

54. The dispenser of claim 52, where the antimicrobial light element comprises an UV-free antimicrobial LED.

55. The dispenser of claim 52, where the surface is a beverage-contacting surface.

56. The dispenser of claim 52, where the nozzle is a bottom-filling nozzle.

57. A beer dispenser comprising one or more of the following: (a) a nozzle comprising a beverage inlet in fluid communication with a beverage outlet to define a beverage flow path, an open configuration operable to dispense a beverage from the nozzle, and a closed configuration operable to store a volume of beverage within the nozzle; (b) a means for selectively purging gas from the nozzle in the closed configuration; (c) a conduit having a conduit inlet in pneumatic communication with a conduit outlet to form a pneumatic flow path, where the conduit inlet is in pneumatic communication with the beverage flow path, and the conduit outlet is in pneumatic communication with ambient; (d) the conduit comprises a channel disposed in the nozzle and providing pneumatic communication between the beverage flow path and ambient; (e) the channel is positioned at the beverage inlet end portion of the nozzle; (f) a valve operable to selectively open and close the pneumatic flow path; (g) the valve is manually operable to selectively open and close the pneumatic flow path; (h) a purge port providing pneumatic communication between the beverage flow path and ambient; (i) a valve operable to selectively open and close the purge port; (j) the valve is manually operable to selectively open and close the purge port; (k) a control system for selectively opening and closing the pneumatic flow path; (l) a control system for selectively opening and closing the purge port; (m) the control system is configured to selectively open and close the purge port based on a predetermined parameter setting; (n) the control system is configured to selectively open and close the pneumatic flow path based on a predetermined parameter setting; (o) the parameter setting is selected from: nozzle purge time, nozzle purge idle time, beverage carbonation level, ambient temperature, beverage temperature, and beverage static pressure; (p) a cooling mechanism in thermal communication with the nozzle; (q) a cooling mechanism in thermal communication with the beverage flow path; (r) a nozzle cooling line having an inlet in fluid communication with an outlet to define a coolant flow path, where the nozzle cooling line is configured to receive refrigerated coolant in the coolant flow path, and where the coolant flow path is in thermal communication with the beverage flow path; (s) the coolant line is at least partly embedded in the nozzle; (t) the coolant line is in thermal communication with the nozzle between the beverage inlet and the beverage outlet; (u) the coolant line is in contact with the nozzle between the beverage inlet and the beverage outlet; (v) an antimicrobial element operable to sanitize a surface of the nozzle; (w) an antimicrobial light element operable to sanitize a surface of the nozzle; (x) an antimicrobial light element coupled to the nozzle and positioned to expose a surface of the nozzle to antimicrobial light radiation at an intensity sufficient to initiate inactivity of microorganisms and disinfect the surface of the nozzle; (y) the surface is a beverage-contacting surface of the nozzle; (z) the antimicrobial element comprises an antimicrobial light element; (aa) the antimicrobial light element comprises an UV-free antimicrobial LED; (bb) the nozzle is a bottom-filling nozzle; (cc) the nozzle comprises an elongate actuator rod portion slidingly disposed within a bore of an elongate body portion, where the actuator rod portion and the body portion cooperate to form the beverage flow path; (dd) a pneumatic conduit having a conduit inlet in pneumatic communication with a conduit outlet to form a pneumatic flow path, where the conduit inlet is in pneumatic communication with the beverage flow path, and the conduit outlet is in pneumatic communication with ambient; (ee) the nozzle is a commercial beverage dispensing nozzle; (ff) the nozzle is a consumer beverage dispensing nozzle; and (gg) the nozzle is an industrial beverage dispensing nozzle.

The following are additional example claims:

1. A beverage dispensing system comprising: a beverage dispenser comprising an elongate nozzle defining a nozzle axis, the nozzle comprising a beverage inlet end in fluid communication with a beverage outlet end to define a beverage flow path therebetween; a first electronic sensor coupled with the nozzle and operable to detect a container presence at a first location relative to the nozzle; a second electronic sensor coupled with the nozzle and operable to detect a container presence at a second location relative to the nozzle; and a controller configured to open the nozzle and dispense a pour when the first sensor detects a container presence at the first location and the second sensor detects a container presence at the second location.

2. The system of claim 1, where the controller is configured to open the nozzle and dispense a pour when a container is detected by the first sensor at the first location and the second sensor at the second location at the same time.

3. The system of claim 1, where the controller is configured to open the nozzle and dispense a pour when a container is detected by the first sensor at the first location prior to the second sensor at the second location.

4. The system of claim 1, where the first sensor is positioned and operable to detect a container presence at a location adjacent the beverage outlet end of the nozzle and the second sensor is positioned and operable to detect a container presence at a location along a length of the nozzle between the beverage outlet and inlet ends.

5. The system of claim 4, where the first sensor is positioned and operable to detect a container presence distal to the beverage outlet end.

6. The system of claim 4, where the first sensor is positioned and operable to detect a container presence at the beverage outlet end.

7. The system of claim 4, further comprising a third electronic sensor coupled with the nozzle and operable to detect a container presence at a third location along a length of the nozzle between the second location and the beverage inlet end of the nozzle.

8. The system of claim 7, where the controller is configured to open the nozzle and dispense a first pour when the container is detected at the second location but not the third location, and a second pour different in volume than the first pour when the container is detected at both the second and third locations.

9. The system of claim 1, further comprising a third electronic sensor coupled with the nozzle and operable to detect a container presence at a third location relative to the nozzle.

10. The system of claim 9, where the controller is configured to open the nozzle and dispense a first pour when the container is detected at the second location but not the third location, and a second pour different in volume than the first pour when the container is detected at both the second and third locations.

11. The system of claim 1, where at least one of the first and second electronic sensors is positioned perpendicular to the axis of the nozzle.

12. The system of claim 1, where at least one of the first and second electronic sensors is positioned parallel to the axis of the nozzle.

13. The system of claim 1, where the first and second sensors each are operable to detect a metallic container presence.

14. The system of claim 13, where the first and second sensors each are operable to detect an aluminum container presence.

15. The system of claim 13, where the first and second sensors are not operable to detect a non-metallic container presence.

16. The system of claim 13, where the first and second sensors are operable not to detect a non-metallic container presence.

17. The system of claim 1, where at least one of the first and second sensors comprises an induction proximity sensor.

18. The system of claim 1, where at least one of the first and second sensors comprises an optical sensor.

19. The system of claim 1, further comprising a container having a characteristic detectable by the first and second sensors.

20. The system of claim 19, where the characteristic comprises a metal.

21. The system of claim 19, where the characteristic comprises aluminum.

22. The system of claim 19, where the characteristic comprises plastic.

23. The system of claim 19, where the characteristic comprises glass.

24. The system of claim 1, where the first and second sensors each comprise an induction proximity sensor.

25. The system of claim 1, where the first and second sensors each comprise an optical sensor.

26. The system of claim 1 comprising one or more of the following: (a) the controller is configured to open the nozzle and dispense a pour when a container is detected by the first sensor at the first location and the second sensor at the second location at the same time; (b) the controller is configured to open the nozzle and dispense a pour when a container is detected by the first sensor at the first location prior to the second sensor at the second location; (c) the first sensor is positioned and operable to detect a container presence at a location adjacent the beverage outlet end of the nozzle and the second sensor is positioned and operable to detect a container presence at a location along a length of the nozzle between the beverage outlet and inlet ends; (d) the first sensor is positioned and operable to detect a container presence distal to the beverage outlet end; (e) the first sensor is positioned and operable to detect a container presence at the beverage outlet end; (f) a third electronic sensor coupled with the nozzle and operable to detect a container presence at a third location along a length of the nozzle between the second location and the beverage inlet end of the nozzle; (g) the controller is configured to open the nozzle and dispense a first pour when the container is detected at the second location but not the third location, and a second pour different in volume than the first pour when the container is detected at both the second and third locations; (h) a third electronic sensor coupled with the nozzle and operable to detect a container presence at a third location relative to the nozzle; (i) the controller is configured to open the nozzle and dispense a first pour when the container is detected at the second location but not the third location, and a second pour different in volume than the first pour when the container is detected at both the second and third locations; (j) at least one of the first and second electronic sensors is positioned perpendicular to the axis of the nozzle; (k) at least one of the first and second electronic sensors is positioned parallel to the axis of the nozzle; (l) the sensors each are operable to detect a metallic container presence; (m) the sensors each are operable to detect an aluminum container presence; (n) the sensors are not operable to detect a non-metallic container presence; (o) the sensors are operable not to detect a non-metallic container presence; (p) at least one of the first and second sensors comprises an induction proximity sensor; (q) at least one of the first and second sensors comprises an optical sensor; (r) a container having a characteristic detectable by the first and second sensors; (s) the characteristic comprises a metal; (t) the characteristic comprises aluminum; (u) the characteristic comprises plastic; and (v) the characteristic comprises glass.

27. A method of dispensing a beverage from a beverage dispensing system comprising a nozzle, the method comprising: operating a first electronic sensor coupled with the nozzle to determine if a container is detected at a first location relative to the nozzle; operating a second electronic sensor coupled with the nozzle to determine if a container is detected at a second location relative to the nozzle; opening the nozzle and dispensing a pour when the first sensor detects a container presence at the first location and the second sensor detects a container presence at the second location.

28. The method of claim 27, where the opening comprises opening the nozzle and dispensing a pour when the first sensor detects a container presence at the first location and the second sensor detects a container presence at the second location at the same time.

29. The method of claim 27, where the first and second electronic sensors are induction proximity sensors.

30. The method of claim 27, where the first and second electronic sensors are optical sensors.

31. The method of claim 27, where the operating a first electronic sensor comprises determining after a container is detected at the first location when a container is no longer detected at the first location, and the opening comprises opening the nozzle and dispensing a pour when a container is no longer detected at the first location and the second sensor detects a container presence at the second location.

32. The method of claim 31, further comprising operating a third electronic sensor coupled with the nozzle to determine if a container is detected at a third location relative to the nozzle; where the opening comprises opening the nozzle and dispensing a first pour when a container is no longer detected at the first location, the second sensor detects a container presence at the second location, and the third sensor does not detect a container presence at the third location.

33. The method of claim 32, where the opening comprises opening the nozzle and dispensing a second pour when a container is no longer detected at the first location, the second sensor detects a container presence at the second location, and the third sensor detects a container presence at the third location, where the second pour is different in volume than the first pour.

34. The method of claim 27, further comprising operating a third electronic sensor coupled with the nozzle to determine if a container is detected at a third location relative to the nozzle.

35. The system of claim 27, where the first and second sensors each are operable to detect a metallic container presence.

36. The system of claim 27, where the first and second sensors each are operable to detect an aluminum container presence.

37. The system of claim 27, where the first and second sensors are not operable to detect a non-metallic container presence.

38. The system of claim 27, where the first and second sensors are operable not to detect a non-metallic container presence.

39. The method of claim 27 comprising one or more of the following: (a) the opening comprises opening the nozzle and dispensing a pour when the first sensor detects a container presence at the first location and the second sensor detects a container presence at the second location at the same time; (b) the electronic sensors comprise induction proximity sensors; (c) the electronic sensors comprise optical sensors; (d) the operating a first electronic sensor comprises determining after a container is detected at the first location when a container is no longer detected at the first location, and the opening comprises opening the nozzle and dispensing a pour when a container is no longer detected at the first location and the second sensor detects a container presence at the second location; (e) operating a third electronic sensor coupled with the nozzle to determine if a container is detected at a third location relative to the nozzle; where the opening comprises opening the nozzle and dispensing a first pour when a container is no longer detected at the first location, the second sensor detects a container presence at the second location, and the third sensor does not detect a container presence at the third location; (f) the opening comprises opening the nozzle and dispensing a second pour when a container is no longer detected at the first location, the second sensor detects a container presence at the second location, and the third sensor detects a container presence at the third location, where the second pour is different in volume than the first pour; (g) operating a third electronic sensor coupled with the nozzle to determine if a container is detected at a third location relative to the nozzle; (h) the sensors each are operable to detect a metallic container presence; (i) the sensors each are operable to detect an aluminum container presence; (j) the sensors are not operable to detect a non-metallic container presence; and (k) the first and second sensors are operable not to detect a non-metallic container presence.

Although the invention has been described and illustrated with reference to specific illustrative examples thereof, it is not intended that the invention be limited to those examples. Those skilled in the art will recognize that variations and modifications can be made without departing from the true scope and spirit of the inventions as defined by the claims that follow. It is therefore intended to include within the inventions all such variations and modifications as fall within the scope of the appended claims and equivalents thereof.

We claim:

1. A beverage dispenser comprising:
a nozzle comprising a beverage inlet in fluid communication with a beverage outlet to define a beverage flow path, an open configuration operable to dispense a beverage from the nozzle, and a closed configuration operable to store a volume of beverage within the nozzle; and
a means for selectively purging gas from the nozzle in the closed configuration.

2. The dispenser of claim 1, where the means for selectively purging comprises a conduit having a conduit inlet in pneumatic communication with a conduit outlet to form a pneumatic flow path, and where the conduit inlet is in pneumatic communication with the beverage flow path, and the conduit outlet is in pneumatic communication with ambient.

3. The dispenser of claim 2, where the conduit comprises a channel disposed in the nozzle and positioned at a beverage inlet end portion of the nozzle, the conduit providing pneumatic communication between the beverage flow path and ambient.

4. The dispenser of claim 2, where the means for selectively purging comprises a valve operable to selectively open and close the pneumatic flow path.

5. The dispenser of claim 1, where the means for selectively purging comprises a purge port providing pneumatic communication between the beverage flow path and ambient.

6. The dispenser of claim 5, where the means for selectively purging comprises a valve operable to selectively open and close the purge port.

7. The dispenser of claim 6, where the valve is manually operable to selectively open and close the purge port.

8. The dispenser of claim 6, comprising a control system for selectively opening and closing the purge port.

9. The dispenser of claim 8, where the control system is configured to selectively open and close the purge port based on a predetermined parameter setting selected from: nozzle purge time, nozzle idle purge time, beverage carbonation level, ambient temperature, beverage temperature, and beverage static pressure.

10. The dispenser of claim 1, comprising a cooling mechanism in thermal communication with at least one of the nozzle and the beverage flow path.

11. The dispenser of claim 1, comprising a nozzle cooling line having an inlet in fluid communication with an outlet to define a coolant flow path, where the nozzle cooling line is configured to receive refrigerated coolant in the coolant flow path, and where the coolant flow path is in thermal communication with the beverage flow path.

12. The dispenser of claim 11, where the coolant line is at least one of: (a) partly embedded in the nozzle; (b) in thermal communication with the nozzle between the beverage inlet and the beverage outlet; and (c) in contact with the nozzle between the beverage inlet and the beverage outlet.

13. The dispenser of claim 1, comprising an antimicrobial element operable to sanitize a beverage-contacting surface of the nozzle.

14. The dispenser of claim 1, where the nozzle comprises an elongate actuator rod portion slidingly disposed within a bore of an elongate body portion, where the actuator rod portion and the body portion cooperate to form the beverage flow path.

15. A beverage dispenser comprising:
a nozzle comprising a beverage inlet in fluid communication with a beverage outlet to define a beverage flow path, an open configuration operable to dispense a beverage from the nozzle, and a closed configuration operable to store a volume of beverage within the nozzle; and
a nozzle cooling line having an inlet in fluid communication with an outlet to define a coolant flow path, where the nozzle cooling line is configured to receive refrigerated coolant in the coolant flow path, and where the coolant flow path is in thermal communication with the beverage flow path.

16. The dispenser of claim 15, where the coolant line is at least one of: (a) partly embedded in the nozzle; (b) in thermal communication with the nozzle between the beverage inlet and the beverage outlet; and (c) in contact with the nozzle between the beverage inlet and the beverage outlet.

17. The dispenser of claim 15, further comprising a means for selectively purging gas from the nozzle in the closed configuration.

18. The dispenser of claim 15, comprising an antimicrobial element operable to sanitize a beverage-contacting surface of the nozzle.

19. A beverage dispenser comprising:
a nozzle comprising a beverage inlet in fluid communication with a beverage outlet to define a beverage flow path; and
an antimicrobial light element coupled to the nozzle and positioned to expose a surface of the nozzle to antimicrobial light radiation at an intensity sufficient to initiate inactivity of microorganisms and disinfect the surface of the nozzle.

20. The dispenser of claim 19, where the antimicrobial light element comprises an antimicrobial LED.

21. The dispenser of claim 19, where the antimicrobial light element comprises an UV-free antimicrobial LED.

22. The dispenser of claim 19, where the nozzle is a bottom-filling nozzle.

23. The dispenser of claim 19, where the nozzle is one of a commercial beverage dispensing nozzle, a consumer beverage dispensing nozzle, and an industrial beverage dispensing nozzle.

24. A beverage dispensing system comprising:
a beverage dispenser comprising an elongate nozzle defining a nozzle axis, the nozzle comprising a beverage inlet end in fluid communication with a beverage outlet end to define a beverage flow path therebetween;
a first electronic sensor coupled with the nozzle and operable to detect a container presence at a first location relative to the nozzle;
a second electronic sensor coupled with the nozzle and operable to detect a container presence at a second location relative to the nozzle; and
a controller configured to open the nozzle and dispense a pour when the first sensor detects a container presence at the first location and the second sensor detects a container presence at the second location.

25. The system of claim 24, where the controller is configured to open the nozzle and dispense a pour when a container is detected by the first sensor at the first location and the second sensor at the second location at the same time.

26. The system of claim 24, where the controller is configured to open the nozzle and dispense a pour when a container is detected by the first sensor at the first location prior to the second sensor at the second location.

27. The system of claim 24, where the first sensor is positioned and operable to detect a container presence at a location adjacent the beverage outlet end of the nozzle and the second sensor is positioned and operable to detect a container presence at a location along a length of the nozzle between the beverage outlet and inlet ends.

28. The system of claim 27, where the first sensor is positioned and operable to detect a container presence distal to the beverage outlet end.

29. The system of claim 27, where the first sensor is positioned and operable to detect a container presence at the beverage outlet end.

30. The system of claim 27, further comprising a third electronic sensor coupled with the nozzle and operable to detect a container presence at a third location along a length of the nozzle between the second location and the beverage inlet end of the nozzle.

31. The system of claim 30, where the controller is configured to open the nozzle and dispense a first pour when the container is detected at the second location but not the third location, and a second pour different in volume than the first pour when the container is detected at both the second and third locations.

32. The system of claim 24, further comprising a third electronic sensor coupled with the nozzle and operable to detect a container presence at a third location relative to the nozzle.

33. The system of claim 32, where the controller is configured to open the nozzle and dispense a first pour when the container is detected at the second location but not the third location, and a second pour different in volume than the first pour when the container is detected at both the second and third locations.

34. The system of claim 24, where the first and second sensors each are operable to detect a metallic container presence.

35. The system of claim 24, where at least one of the first and second sensors comprises an induction proximity sensor.

36. The system of claim 24, where at least one of the first and second sensors comprises an optical sensor.

37. The system of claim 24, further comprising a container having a characteristic detectable by the first and second sensors, the characteristic comprising at least one of: (a) a metal; (b) aluminum; (c) plastic; and (d) glass.

38. A method of dispensing a beverage from a beverage dispensing system comprising a nozzle, the method comprising:
operating a first electronic sensor coupled with the nozzle to determine if a container is detected at a first location relative to the nozzle;
operating a second electronic sensor coupled with the nozzle to determine if a container is detected at a second location relative to the nozzle; and
opening the nozzle and dispensing a pour when the first sensor detects a container presence at the first location and the second sensor detects a container presence at the second location.
